(19) United States
(12) Patent Application Publication
(10) Pub. No.: US 2009/0117915 A1
(43) Pub. Date: May 7, 2009

(54) MOBILE DEVICE AND METHOD OF OBTAINING POSITION DATA OF THE SAME

(75) Inventors: Yun Jong LEE, Seoul (KR); Tae Keun Oh, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 12/057,195

(22) Filed: Mar. 27, 2008

(30) Foreign Application Priority Data
Nov. 6, 2007 (KR) 10-2007-0112840

(51) Int. Cl. H04Q 7/20

(52) U.S. Cl. 455/456.1

(57) ABSTRACT

A mobile device providing position data of its own, the mobile device including: a Zigbee communication module executing Zigbee communication according to IEEE 802.15.4 standards; a global positioning system (GPS) module receiving a GPS signal and obtaining the position data of the mobile device; and a mobile communication module checking whether the mobile device departs a Zigbee communication network while executing the Zigbee communication via the Zigbee communication module, obtaining the position data of the mobile device via the GPS module when the mobile device departs the Zigbee communication network, and transmitting a position signal including the position data to a predetermined destination address.

### CROSS-REFERENCE TO RELATED APPLICATIONS

This application claims the priority of Korean Patent Application No. 2007-0112840 filed on Nov. 6, 2007, in the Korean Intellectual Property Office, the disclosure of which is incorporated herein by reference.

### BACKGROUND OF THE INVENTION

1. Field of the Invention

The present invention relates to a method of obtaining a position of a mobile device using a Zigbee communication network and a global positioning system (GPS), and more particularly, to a method of obtaining a position of a mobile device, the method in which the position is checked by using a Zigbee communication network and checking the position by using a GPS when the mobile device departs the Zigbee communication network.

2. Description of the Related Art

In general, a Zigbee communication network is wireless personal area network (PAN) technology according to IEEE 802.15.4 standards, in which frequency bandwidths of 868 MHz, 915 MHz, and 2.4 GHz are used, direct sequence spread spectrum DSSS modulation method and carrier sense multiple access with collision avoidance (CSMA/CA) media access control (MAC) channel access (channel allocation) method are applied, data transmission rate is 250, 40, and 20 Kbps, a transmission distance is 10 to 75 m, the number of nodes is 254, a channel bandwidth is 6000 KHz, 2 MHz, and 5 MHz, and transmission power is −40 to 20 dBm.

FIG. 1 is a configuration of a conventional positioning system for positioning a mobile device.

Referring to FIG. 1, the positioning system includes a plurality of second layer Zigbee communication devices 11, a plurality of first layer Zigbee communication devices 12, a Zigbee terminal 13, a network access device 14, a positioning service server 16 and a user terminal 17, connected via a network 15.

The positioning system of FIG. 1 is a conventional positioning service system based on Zigbee communication, corresponding to when coupling with a wireless local area network (WLAN) or an asymmetric digital subscriber line (ADSL) network.

Referring to FIG. 1, the second layer Zigbee communication device 11 receives identification information from the first layer Zigbee communication device 12 to periodically communicate. The first layer Zigbee communication device 12 receives identification information of its own from the Zigbee terminal and communicates. When the second layer Zigbee communication device 11 is sensed, the first layer Zigbee communication device 12 notifies the Zigbee terminal 13 of that the second layer Zigbee communication device 11 is sensed. The first layer Zigbee communication device 12 receives identification information from the Zigbee terminal 13 and transfer the identification information to the second layer Zigbee communication device 11. When the second layer Zigbee communication device 11 connected thereto departs a communication area, the first layer Zigbee communication device 12 notifies the Zigbee terminal 13 of that the second layer Zigbee communication device 11 departs the communication area. When the first layer Zigbee communication device 12 is sensed or information that the second layer zigbee communication device 11 is sensed is transferred from the first layer Zigbee communication device 12, the Zigbee terminal 13 assigns identification information and transfers access information with each of the first and second layer Zigbee communication devices 12 and 11 to the positioning service system 16 via the network access device 14. The network access device 14 allows the Zigbee terminal 13 to access a network. The positioning service system 16 administrates the access information received from the Zigbee terminal 13 via the network access device 14 and provides corresponding access information in response to a request for the access information from the user terminal 17.

Also, the Zigbee terminal 13 is a wireless communication terminal equipped with a Zigbee communication device. When the first layer zigbee communication device 12 is out of the communication area and does not access within a certain amount of time or the second layer Zigbee communication device 11 does not access the first layer Zigbee communication device 12 or another first layer Zigbee communication device 12 within a predetermined amount of time after access release of the second layer Zigbee communication device 11 is received via the first layer Zigbee communication device 11, a warning sound may be outputted.

In addition, the first and second layer Zigbee communication devices 12 and 11 periodically operate in activated/deactivated modes to control power consumption. When the first and second layer Zigbee communication devices 12 and 11 are deactivated from an activated mode and are activated again, access change information at each node according to migration of the first and second layer Zigbee communication devices 12 and 11 in a previous activated mode is transferred to the Zigbee terminal 13.

A positioning method applied to the positioning system for positioning a mobile device as described above is performed as shown in FIG. 2.

FIG. 2 is a flowchart illustrating a conventional positioning method using a Zigbee communication network. The conventional positioning method for positioning a mobile device will be described with reference to FIG. 2.

Referring to FIGS. 1 and 2, the Zigbee terminal 13 and the first and second layer Zigbee communication devices 12 and 11 are activated, thereby forming each node (layer) and transferring access information of the first and second layer Zigbee communication devices 12 and 11 on the node to the positioning service server 16 (S11).

Describing a process of forming the node, when the Zigbee terminal 13 and the first and second layer Zigbee communication devices 12 and 11 are activated and the Zigbee terminal 13 senses the first and second layer Zigbee communication devices 12 and 11, the sensed Zigbee communication device is set as the first layer Zigbee communication device 12 and identification information is transferred to the first layer Zigbee communication device 12. When the first layer zigbee communication device 12 senses another Zigbee communication device, the sensed Zigbee communication device is set as the second layer Zigbee communication device 11. The Zigbee terminal 13 transfers identification information to the second layer Zigbee communication device 11 via the first layer Zigbee communication device 12. The node is formed via the process as described above.

The positioning service system 16 stores the transferred access information in a database (S12).

As an access state of the first and second layer Zigbee communication devices 12 and 11 is changed, the Zigbee terminal 13 transfers change information to the positioning service server 16 to be updated (S13)

According to a positioning request from the user terminal 17, corresponding access information is provided (S14).

As described above, according to the conventional positioning method for positioning a mobile device, a user terminal requests a positioning service server of access information of a Zigbee terminal by using a Zigbee communication and receives access position data, thereby checking a position of the Zigbee terminal at the user terminal.

However, when the Zigbee terminal or the user terminal is out of a Zigbee communication network, it is impossible to receive positioning services.

### SUMMARY OF THE INVENTION

An aspect of the present invention provides a method of positioning a mobile device using a Zigbee communication network, in which a global positioning system (GPS) is used to detect a position of the mobile device when the mobile device is out of the Zigbee communication network.

According to an aspect of the present invention, there is provided a mobile device providing position data of its own, the mobile device including: a Zigbee communication module executing Zigbee communication according to IEEE 802.15.4 standards; a global positioning system (GPS) module receiving a GPS signal and obtaining the position data of the mobile device; and a mobile communication module checking whether the mobile device departs a Zigbee communication network while executing the Zigbee communication via the Zigbee communication module, obtaining the position data of the mobile device via the GPS module when the mobile device departs the Zigbee communication network, and transmitting a position signal including the position data to a predetermined destination address.

The position signal may be a short message service (SMS) signal including the position data of the mobile device.

The position signal may include Zigbee communication network departure information.

The mobile communication module may determine that the mobile device departs the zigbee communication network, when an intensity of a Zigbee communication signal received via the Zigbee communication is smaller than a reference value.

According to an aspect of the present invention, there is provided a method of obtaining position data, at a mobile device including a zigbee communication module executing zigbee communication according to IEEE 802.15.4 standards; a GPS module receiving a GPS signal and obtaining position data of the mobile device; and a mobile communication module obtaining the position data of the mobile device by using the GPS module and the GPS module and transmitting a position signal including the position data to a predetermined destination address, the method including: initiating the mobile device and the zigbee communication module; executing Zigbee communication by using the Zigbee communication module and providing the position data of the mobile device to a coordinator of a Zigbee communication network; checking whether the mobile device departs the Zigbee communication network while executing the Zigbee communication; and obtaining the position data of the mobile device via the GPS module when the mobile device departs the Zigbee communication network and transmitting the position signal including the position data to the predetermined destination address.

The position signal may be an SMS signal including the position data of the mobile device.

The position signal may include departure information indicating that the mobile device departs the Zigbee communication network.

The mobile communication module may determine that the mobile device departs the Zigbee communication network, when an intensity of a Zigbee communication signal received via the Zigbee communication is smaller than a reference value.

The obtaining of the position data of the mobile device and transmitting of the position signal may be repeatedly performed until the Zigbee communication network is detected.

The obtaining of the position data of the mobile device and transmitting of the position signal may include: starting operation of the GPS module; obtaining the position data of the mobile device via the GPS module; transmitting the position data of the mobile device to the predetermined destination address via the GPS module; and executing the obtaining of the position data when the Zigbee communication network is not searched and finishing the obtaining of the position data and transmitting of the position signal when the Zigbee communication network is detected.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating a conventional positioning system for positioning a mobile device;

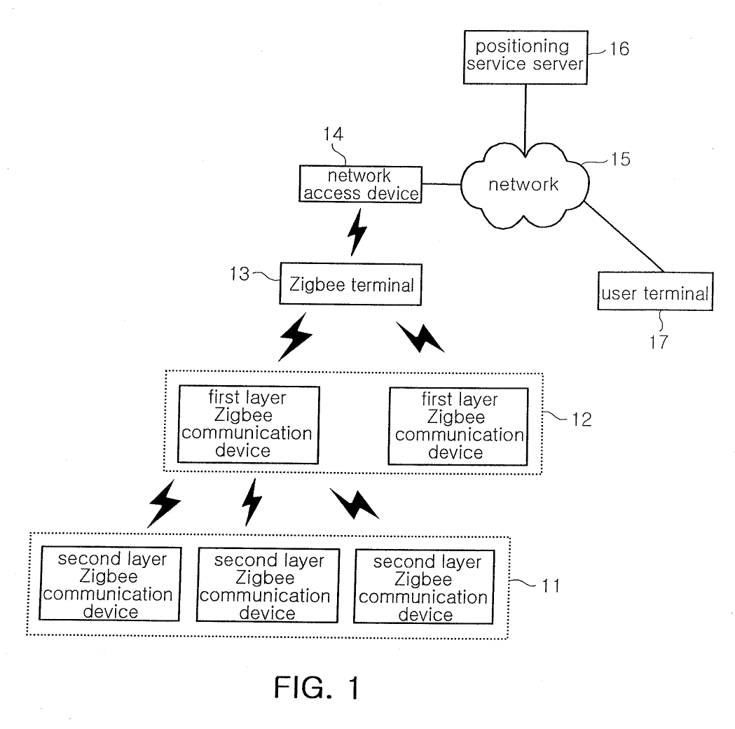

FIG. 2 is a flowchart illustrating a conventional positioning method using a Zigbee communication network;

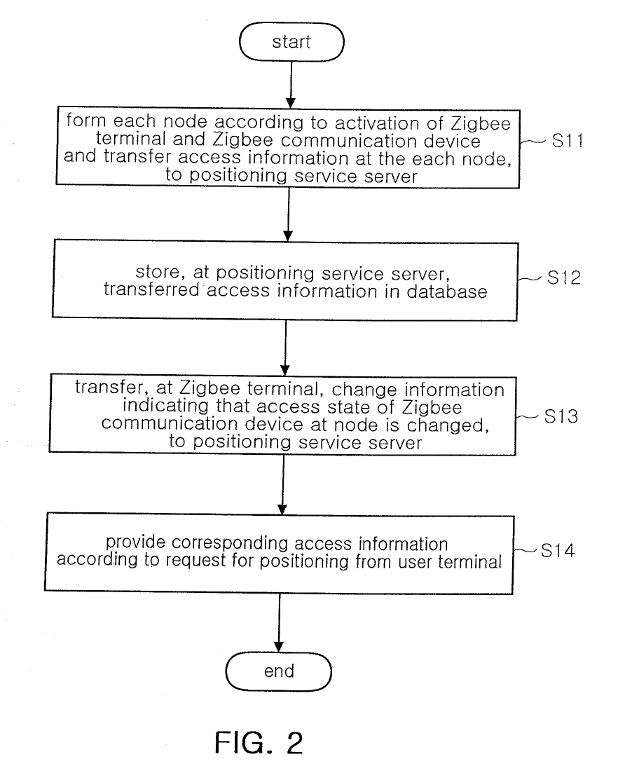

FIG. 3 is a configuration diagram illustrating a mobile device according to an exemplary embodiment of the present invention;

FIG. 4 is a configuration diagram illustrating a positioning system for positioning the mobile device according to an exemplary embodiment of the present invention;

FIG. 5 is a flowchart illustrating a method of positioning the mobile device according to an exemplary embodiment of the present invention; and

FIG. 6 is a flowchart illustrating a global positioning system (GPS) execution process of the mobile device according to an exemplary embodiment of the present invention.

### DETAILED DESCRIPTION OF THE PREFERRED EMBODIMENT

Hereinafter, exemplary embodiments of the present invention will now be described in detail with reference to the accompanying drawings.

The present invention will not be embodiments that will be described. The embodiments are used for understanding technical features of the present invention. Like reference numerals in the drawings denote like elements.

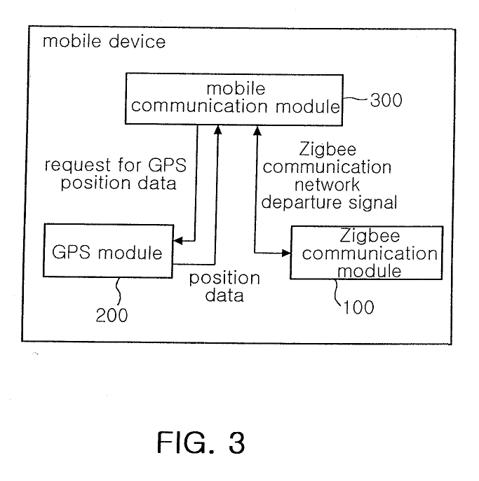

FIG. 3 is a configuration diagram illustrating a mobile device according to an exemplary embodiment of the present invention.

Referring to FIG. 3, the mobile device providing position data of its own includes a Zigbee communication module 100 executing a Zigbee communication according to IEEE 802.15.4 standards, a global positioning system (GPS) module 200 obtaining the position data of the mobile device, and a mobile communication module 300 checking whether the mobile device departs a Zigbee communication network while executing the Zigbee communication via the Zigbee communication module 100, obtaining position data of the mobile device via the GPS module 200 when the mobile device departs the Zigbee communication network, and transmitting a position signal including the position data to a predetermined destination address.

In this case, the mobile device may be added to the Zigbee communication network as one node and perform the zigbee communication. A detailed description on admission to the Zigbee communication will be omitted since the admission is a general process.

In this case, the position signal may be a short message service (SMS) signal including position data of a mobile device. Also, the position signal may include information on a departure from the Zigbee communication network.

Also, the mobile communication module 300 may determine that the mobile device departs the zigbee communication network, when an intensity of a zigbee communication signal received via the Zigbee communication is smaller than a reference value.

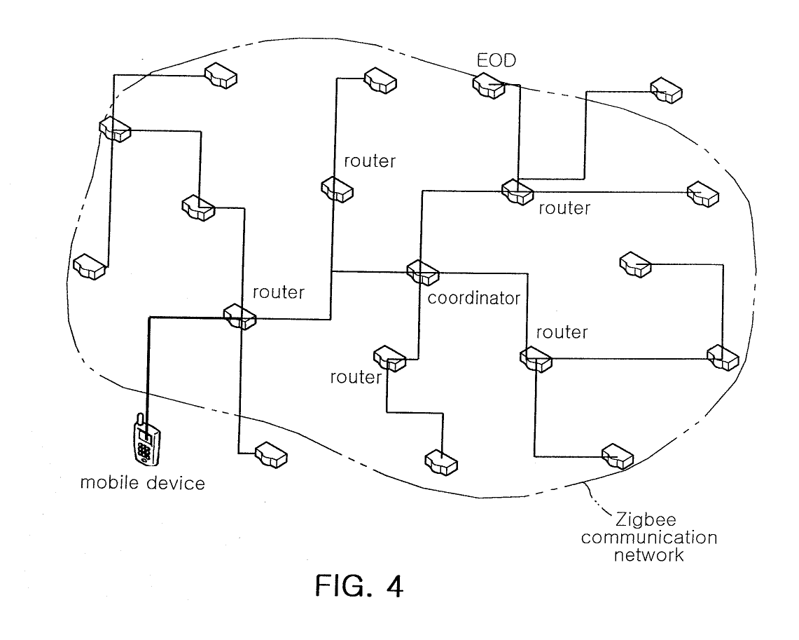

FIG. 4 is a configuration diagram illustrating a positioning system for positioning a mobile device, according to an exemplary embodiment of the present invention.

Referring to FIG. 4, the positioning system includes the mobile device, a plurality of routers executing a Zigbee communication with the mobile device, and a coordinator wired-connected to the plurality of routers to execute communication and executing the Zigbee communication with the mobile device.

The coordinator may obtain position data of a mobile device connected to a Zigbee communication network. The obtained position data may be variously used.

For example, the position data may be transmitted to a designated terminal in the Zigbee communication network and may be transmitted to a designated phone number when the coordinator is capable of using a telephone network.

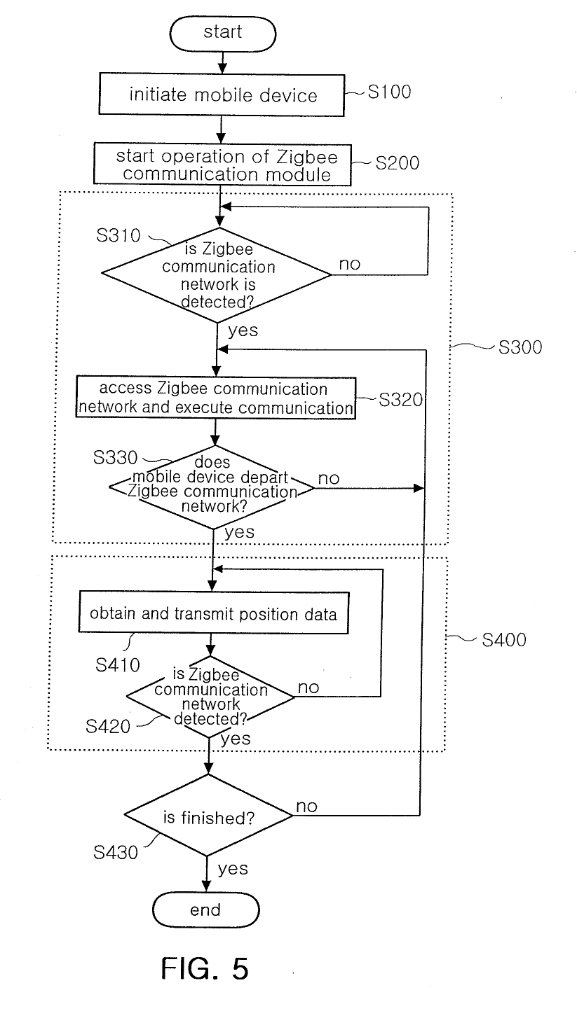

FIG. 5 is a flowchart illustrating a method of positioning a mobile device, according to an exemplary embodiment of the present invention.

Referring to FIG. 5, the method is performed at the mobile device including the Zigbee communication module 100 executing the Zigbee communication according to IEEE 802.15.4 standards, the GPS module 200 receiving a GPS signal and obtaining position data of the mobile device, and the mobile communication module 300 obtaining the position data of the mobile device by using the Zigbee communication module 100 and the GPS module 200 and transmitting a position signal including the position data to a predetermined destination address. The mobile device and the Zigbee communication module 100 is initiated (S100). The mobile device provides position data of its own to the coordinator of the Zigbee communication network while executing the Zigbee communication by using the Zigbee communication module 100 (S200). While the mobile device executes the Zigbee communication, it is determined whether the mobile device departs the Zigbee communication network (S300). When the mobile device departs the Zigbee communication network, position data of the mobile device is obtained via the GPS module 200 and a position signal including the position data of the mobile device is transmitted to a predetermined destination address (S400).

In this case, the position signal may be an SMS signal including the position data of the mobile device. The position signal may include departure information indicating that the mobile device departs the Zigbee communication network.

Also, the mobile communication module 300, when an intensity of a Zigbee communication signal received via the Zigbee communication is smaller than a reference value, may determine that the mobile device departs the Zigbee communication network.

S400 may include operations of obtaining and transmitting the position data (S410) and determining whether the Zigbee communication network is detected (S420). Also, the method of positioning the mobile device may include an operation of determining whether the overall process is finished and performing S300 when the overall process is not finished (S430).

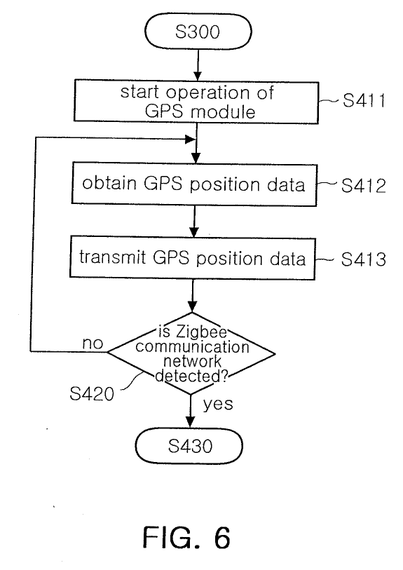

FIG. 6 is a flowchart illustrating sub-operations of S400 of FIG. 5.

Referring to FIG. 6, the obtaining and transmitting the position data (S410) will be described. S410 includes operations of initiating operation of the GPS module 200 (S411), obtaining the position data of the mobile device via the GPS module 200 (S412), and transmitting the position data of the mobile device to a predetermined destination address via the GPS module 200 (S413). When a Zigbee communication network is not detected in S420, S412 is performed. When the Zigbee communication network is detected, S400 is finished.

Hereinafter, operations and effects of the present invention will be described in detail with reference to the attached drawings.

Referring to FIGS. 3 and 4, the mobile device includes the zigbee communication module 100, the GPS module 200, and the mobile communication module 300.

Referring to FIGS. 3 and 4, the Zigbee communication module 100 executes the Zigbee communication according to the IEEE 802.15.4 standards and notifies the coordinator of position of its own via the plurality of routers.

As described above, the mobile device equipped with the Zigbee communication module 100 is in a state in which position data of the mobile device is capable of being known via the coordinator. For example, the position data may be transmitted to a designated terminal in the Zigbee communication network. When the coordinator is capable of using a telephone network, the position data may be transmitted to a designated telephone number.

While executing the Zigbee communication, the mobile communication module 300 repeatedly checks whether the mobile device departs the Zigbee communication network, based on a Zigbee communication signal received via the Zigbee communication module 100.

In this case, the mobile communication module 300, when an intensity of the Zigbee communication signal received via the Zigbee communication is smaller than a reference value, may determine that the mobile device departs the Zigbee communication network.

The mobile communication module 300, when the mobile device departs the Zigbee communication network, obtains position data of the mobile device by using the GPS module 200.

That is, the GPS module 200 receives a GPS signal, obtains the position data of the mobile device, and provides the position data to the mobile communication module 300.

The mobile communication module 300, when the mobile device departs the Zigbee communication network, obtains the position data of the mobile device via the GPS module 200 and transmits a position signal including the position data to a predetermined destination address.

In this case, the position signal may be an SMS signal including the position data of the mobile device. Also, the position signal may include information on a departure from the Zigbee communication network.

The destination address may be a phone number of a mobile phone or personal digital assistant (PDA). In this case, the position data of the mobile device departing the Zigbee communication network may be transmitted to a designated phone number by using a telephone network.

As described above, according to the mobile device according to the present embodiment, in the case of mobile terminals or mobile apparatuses to which the mobile device according to the present embodiment is applied, position data thereof is monitored via the Zigbee communication network. When the mobile terminals or the mobile apparatuses depart the Zigbee communication network, GPS position data is automatically obtained and departure information and the position data may be transmitted to a designated terminal or system such as mobile phones. Accordingly, a loss or a robbery of the mobile device is capable of being accurately prevented. Particularly, when a child wears the mobile device, a missing child may be definitely, previously prevented.

Hereinafter, referring to FIGS. 3 to 6, the method of positioning the mobile device according to an exemplary embodiment of the present invention, will be described.

In FIG. 4, in S100, the mobile device and a Zigbee communication module are initiated. That is, when the mobile device is powered on, power is supplied to the mobile communication module 300 and the Zigbee communication module 100 and each module is initiated.

In S200, while executing a Zigbee communication by using the Zigbee communication module 100, position data of the mobile device is provided to a coordinator of a Zigbee communication network.

Accordingly, the mobile device equipped with the Zigbee communication is in a state in which the position data of its own is capable of being known via the coordinator. For example, when it is set that the position data is to be transmitted to a previously set destination address, the coordinator will transmit the position data of the mobile device to the destination address.

In S300, while executing the Zigbee communication, it is determined whether the mobile device departs the Zigbee communication network.

In S400, when the mobile device departs the Zigbee communication network, position data of the mobile device is obtained via the GPS module 200 and a position signal including the obtained position data of the mobile device is transmitted to a predetermined destination address.

In this case, the position signal may be an SMS signal including the position data of the mobile device and may include departure information indicating that the mobile device departs the Zigbee communication network.

For example, since message information including position data is transmitted to a predetermined phone number and a terminal corresponding to the phone number receives the message information including position data, it may be known whether a mobile device departs a designated Zigbee communication network and a present position of the mobile device may be known.

S400 may be repeatedly performed until a Zigbee communication network is detected. When the Zigbee communication network is detected, S400 is finished and S200 is performed.

Referring to FIGS. 3 and 6, S400 will be described.

The S400 includes S411, S412, S413, and S420.

In this case, in S411, operation of the GPS module 200 is started. Power is supplied to the GPS module 200 to be initiated.

In S412, position data of the mobile device is obtained via the GPS module 200 and provided to the mobile communication module 300.

In S413, the mobile communication module 300 transmits the position data of the mobile device to a predetermined destination address via the GPS module 200.

In S420, when a zigbee communication network is not detected, S412 is performed. Also, when the Zigbee communication network is detected, S400 is finished.

That is, according to an aspect of the present invention, there are provided a mobile device and for providing positioning services based on a Zigbee communication network and a method of positioning the mobile device. A network is formed of a plurality of nodes included in the Zigbee communication network and the mobile device equipped with a Zigbee communication module. When the mobile device departs the Zigbee communication network, that is, is disconnected from the Zigbee communication network, the mobile device may generate an interrupt, obtain position data of the mobile device by using GPS, and transmit the obtained position data to a designated destination address.

As described above, using a conventional Zigbee communication network, a device that needs being monitored is added to the Zigbee communication network and monitored. When the device departs a designated Zigbee communication network, position data of the device is transmitted to a designated terminal or system by suing GPS to quickly and precisely check a position of the device. Accordingly, for example, when applying the present invention to crowded outdoors or using the present invention for administrating small arms in army, though a child is missed or a gun is lost, position data thereof may be continuously provided, thereby preventing various accidents.

While the present invention has been shown and described in connection with the exemplary embodiments, it will be apparent to those skilled in the art that modifications and variations can be made without departing from the spirit and scope of the invention as defined by the appended claims.

What is claimed is:

1. A mobile device providing position data of its own, the mobile device comprising:
a Zigbee communication module executing Zigbee communication according to IEEE 802.15.4 standards;
a global positioning system (GPS) module receiving a GPS signal and obtaining the position data of the mobile device; and
a mobile communication module checking whether the mobile device departs a Zigbee communication network while executing the Zigbee communication via the zigbee communication module, obtaining the position data of the mobile device via the GPS module when the mobile device departs the Zigbee communication network, and transmitting a position signal comprising the position data to a predetermined destination address.

2. The mobile device of claim 1, wherein the position signal is a short message service (SMS) signal comprising the position data of the mobile device.

3. The mobile device of claim 1, wherein the position signal comprises Zigbee communication network departure information.

4. The mobile device of claim 1, wherein the mobile communication module determines that the mobile device departs the Zigbee communication network, when an intensity of a Zigbee communication signal received via the Zigbee communication is smaller than a reference value.

5. A method of obtaining position data, at a mobile device comprising a zigbee communication module executing Zigbee communication according to IEEE 802.15.4 standards; a GPS module receiving a GPS signal and obtaining position data of the mobile device; and a mobile communication module obtaining the position data of the mobile device by using the GPS module and the GPS module and transmitting a position signal comprising the position data to a predetermined destination address, the method comprising:
initiating the mobile device and the Zigbee communication module;
executing zigbee communication by using the Zigbee communication module and providing the position data of the mobile device to a coordinator of a Zigbee communication network;
checking whether the mobile device departs the Zigbee communication network while executing the Zigbee communication; and
obtaining the position data of the mobile device via the GPS module when the mobile device departs the Zigbee communication network and transmitting the position signal comprising the position data to the predetermined destination address.

6. The method of claim 5, wherein the position signal is an SMS signal comprising the position data of the mobile device.

7. The method of claim 5, wherein the position signal comprises departure information indicating that the mobile device departs the Zigbee communication network.

8. The method of claim 5, wherein the mobile communication module determines that the mobile device departs the Zigbee communication network, when an intensity of a Zigbee communication signal received via the Zigbee communication is smaller than a reference value.

9. The method of claim 5, wherein the obtaining of the position data of the mobile device and transmitting of the position signal is repeatedly performed until the Zigbee communication network is detected.

10. The method of claim 5, wherein the obtaining of the position data of the mobile device and transmitting of the position signal comprises:
starting operation of the GPS module;
obtaining the position data of the mobile device via the GPS module;
transmitting the position data of the mobile device to the predetermined destination address via the GPS module; and
executing the obtaining of the position data when the Zigbee communication network is not searched and finishing the obtaining of the position data and transmitting of the position signal when the Zigbee communication network is detected.
